(19) United States
(12) Patent Application Publication
(10) Pub. No.: US 2026/0059017 A1
(43) Pub. Date: Feb. 26, 2026

(54) METHODS OF SHARING OF ADMINISTRATIVE DATA BETWEEN NETWORK DOMAINS

(71) Applicant: HUAWEI TECHNOLOGIES CO., LTD., Shenzhen (CN)

(72) Inventor: Xun Xiao, Munich (DE)

(21) Appl. No.: 19/375,383

(22) Filed: Oct. 31, 2025

Related U.S. Application Data
(63) Continuation of application No. PCT/EP2023/061674, filed on May 3, 2023.

(51) Int. Cl. H04L 67/1095; H04L 9/00; H04L 9/32

(52) U.S. Cl. CPC H04L 67/1095; H04L 9/3213; H04L 9/50; H04L 2209/463

(57) ABSTRACT

Disclosed is a method of sharing of administrative data between network domains. The method comprises: receiving a first administrative data record of a first set of administrative data records from a user plane function of the respective network domain; sending the first administrative data record by a sharing function of the respective network domain; receiving a second administrative data record of a second set of administrative data records by the sharing function of the respective network domain; verifying the first and/or second administrative data records; selecting a leader among the sharing functions of the network domains; and committing a third administrative data record of the first and second sets of administrative data records to a local copy of a distributed ledger of the network domains.

### CROSS-REFERENCE TO RELATED APPLICATIONS

This application is a continuation of International Application No. PCT/EP2023/061674, filed on May 3, 2023, the disclosure of which is hereby incorporated by reference in its entirety.

### TECHNICAL FIELD

The present disclosure relates generally to the field of cross-domain network operation, administration and management (OAM), and particularly to methods of sharing of administrative data between network domains.

### BACKGROUND ART

Energy consumption (EC) in telecommunications is still increasing because of the ongoing massive deployment of the 5th generation (5G) mobile network. This will be more severe in the next generation (e.g., 6G) where the scale of the network infrastructure will become even larger. The key reasons are much denser radio access networks (RAN) due to usage of a higher frequency spectrum such as Terahertz, and much heavier demand for compute capabilities for energy-hungry applications such as artificial intelligence (AI) and immersive extended reality (XR) services such as augmented reality (AR) and virtual reality (VR).

Vendors, operators, and service providers all agree on the importance of energy efficiency (EE) and explore possible solutions approaching a green and sustainable transformation. In the next release (i.e., Release 19), EE is expected to be a native service criterion of a 3^{rd} generation partnership programme (3GPP) system. A fine-grained EE assessment such as per communication session will be available to not only the operator and service provider sides, but also the end user side, which provides an end-to-end awareness of EC.

Today, measurements typically consider a data volume (DV) consumption of a flow session, while the EC of a flow session is not specified.

Such measurements tend to take place within administrative domains. As flow sessions may extend beyond the boundaries of the domain, an owner (e.g., an operator) of a domain cannot always have a full picture of the associated EC.

Cross-domain sharing of measurements is difficult, due to a lack of standardized interfaces and procedures.

Sharing administrative data such as measurement data is sensitive due to data privacy. This is why nowadays many auditing needs among multiple participants still rely on a trusted but centralized third party authority.

### SUMMARY

It is an object to overcome the above-mentioned and other drawbacks.

The foregoing and other objects are achieved by the features of the independent claims. Further implementation forms are apparent from the dependent claims, the description and the figures.

According to a first aspect, a method of sharing of administrative data between network domains is provided. The method comprises: receiving a first administrative data record of a first set of administrative data records from a user plane function of the respective network domain; sending the first administrative data record by a sharing function of the respective network domain; receiving a second administrative data record of a second set of administrative data records by the sharing function of the respective network domain; verifying the first and/or second administrative data records; selecting a leader among the sharing functions of the network domains; and committing a third administrative data record of the first and second sets of administrative data records to a local copy of a distributed ledger of the network domains.

“Administrative data” as used herein may refer to any data being collected, shared and utilized for operation, administration and management (OAM) of a network domain. For example, administrative data may comprise measurement data.

An “administrative data record” as used herein may refer to an elementary unit of administrative data.

A “network domain” as used herein may refer to one or more network elements being subject to a same OAM authority.

A “user plane function” (UPF) as used herein may refer to a functional component of the data plane of the core network in the 3GPP 5G system architecture. For example, UPFs may be configured for packet routing and data forwarding between the RAN and any data networks (DN), measurement and reporting of administrative data, and the like.

A “sharing function” as used herein may refer to a functional component of the control plane of the 3GPP 5G system architecture. Sharing functions may be instantiated congruently with corresponding UPFs. Sharing functions may be configured for local collection and cross-domain sharing of administrative data.

A “leader” as used herein may refer to a leading role among the sharing functions of a plurality of network domains. The leading role coincides with a distinguished behavior in a procedure of cross-domain sharing of administrative data.

A “distributed ledger” as used herein may refer to a database of transactions run by a distributed plurality of parties on the basis of consensus, wherein administrative data records constitute the transactions. For example, distributed ledgers may be organized as a linear chain of blocks of transactions (block chain concept) or as a directed acyclic graph (DAG) of individual transactions (DAG concept). Typically, a non-hierarchical network of nodes, such as a peer-to-peer network, maintains (ideally) identical local copies of the distributed ledger per node, wherein committing (i.e., adding) new records to the local copies of the distributed ledger is governed by the consensus among the involved parties.

The method enables automated and decentralized sharing of administrative data relating to a flow session across different domains, and thereby avoids a dependency on a trusted third-party authority mediating the data sharing process and improves multi-party transparency and trustworthiness.

In a possible implementation form, committing the third administrative data record of the first and second sets of administrative data records to the local copy of the distributed ledger of the network domains may comprise: sending a ledger data block and a token of the leader by the leader, the ledger data block comprising the third administrative data record and a reference to a preceding ledger data block of the local copy of the distributed ledger; appending the ledger data block to the preceding ledger data block; and receiving a confirmation by the leader.

A “ledger data block” as used herein may refer to an elementary record of a distributed ledger, including a block of administrative data records and a reference to a preceding block (block chain concept), or including an individual administrative data record and references to preceding administrative data records (DAG concept).

A “token” as used herein may refer to information based on which non-leaders can verify a legitimation of the leader.

A “reference” as used herein may refer to a verifiable hash value of an existing ledger data block in the local copy of the digital ledger.

In a possible implementation form, committing the third administrative data record of the first and second sets of administrative data records to the local copy of the distributed ledger of the network domains may comprise: receiving a ledger data block and a token of the leader by a non-leader, the ledger data block comprising the third administrative data record and the reference to the preceding ledger data block of the local copy of the distributed ledger; verifying the third administrative data record; verifying the token of the leader; appending the ledger data block to the preceding ledger data block; and sending a confirmation to the leader.

In a possible implementation form, selecting the leader among the sharing functions of the network domains may comprise one of: running an interactive consensus-building algorithm among the sharing functions; and running a non-interactive consensus-building algorithm by the respective sharing function.

A “consensus-building algorithm” as used herein may refer to an algorithm for reaching a consensus among involved parties (i.e., sharing functions). In accordance with various existing protocols, a consensus may be achieved interactively, wherein multiple rounds of signaling among the involved parties are required (e.g. PBFT, RAFT, PAXOS, Proof-of-Stake) or non-interactively (e.g., Proof-of-Work).

According to a second aspect, a method of sharing of administrative data between network domains is provided. The method comprises: receiving a first administrative data record of a first set of administrative data records from a user plane function of the respective network domain; verifying the first administrative data record; committing the first administrative data record to a local copy of a distributed ledger of the network domains; receiving a second ledger data block by the sharing function of the respective network domain, the second ledger data block comprising a second administrative data record of a second set of administrative data records and a reference to a second preceding administrative data record of the local copy of the distributed ledger; verifying the second administrative data record; and committing the second administrative data record to the local copy of the distributed ledger of the network domains.

The technical effects and advantages described above in relation with the method of the first aspect equally apply to the method of the second aspect having special technical features.

In a possible implementation form, verifying the second administrative data record may comprise recursively updating the local copy of the distributed ledger in accordance with the reference to the second preceding administrative data record until the local copy comprises the second preceding administrative data record.

In a possible implementation form, committing the first administrative data record to the local copy of the distributed ledger of the network domains may comprise appending a first ledger data block to a first preceding ledger data block of the local copy of the distributed ledger, the first ledger data block comprising the first administrative data record and a reference to the first preceding ledger data block; and sending the first ledger data block by a sharing function of the respective network domain.

In a possible implementation form, committing the second administrative data record to the local copy of the distributed ledger of the network domains may comprise appending the second ledger data block to the second preceding administrative data record.

In a possible implementation form, appending the ledger data block to the local copy of the distributed ledger may comprise one of: appending the ledger data block by referencing a last ledger data block of the local copy; and appending the ledger data block by referencing one or more last ledger data blocks of the local copy being determined by weighted random walks of the same.

A “last” ledger data block as used herein may refer to a ledger data block to which no reference is made (yet).

A “weighted random walk” as used herein may refer to a procedure for determining an attachment point (i.e., one of the last ledger data blocks) within a local copy of a DAG-based digital ledger, wherein the weights may be generated in accordance with a policy defined as system configuration.

In a possible implementation form, the respective administrative data record may comprise measurement data of a traffic flow.

A “traffic flow” as used herein may refer to a flow of traffic (i.e., data plane packets) from a source network entity via the measuring UPF to a destination network entity.

In a possible implementation form, the measurement data may comprise: energy consumption measurement data of the traffic flow, and data volume measurement data of the traffic flow.

An “energy consumption” as used herein may refer to a total amount of energy consumption measured in a given time period and being measured in kilowatt hours (kWh).

A “data volume” as used herein may refer to a total amount of data measured in a given time period and being measured in gigabytes (GB).

Thereby, collection and cross-domain sharing of both EC and DV measurement data is facilitated.

In a possible implementation form, the data volume measurement data of the traffic flow may comprise: an identifier of the traffic flow; an identifier of a source network entity of the traffic flow; an identifier of a destination network entity of the traffic flow; a time period; a data volume of the traffic flow during the time period; and a signature of the user plane function of the respective network domain.

A “signature” as used herein may refer to a verifiable digital signature of an identifiable entity.

In a possible implementation form, the respective administrative data record may comprise: an identifier of the user plane function of the network domain; the measurement data of the traffic flow; one or more pointers to administrative data records for the traffic flow at ingress network entities; and a signature of the sharing function of the respective network domain.

A “pointer” as used herein may refer to a reference to an administrative data record, which may be retrieved by dereference (i.e., indirection).

In a possible implementation form, the ledger data block may comprise: one or more administrative data records, and one or more references to the preceding ledger data blocks or to the preceding administrative data records.

In a possible implementation form, verifying the first and/or the second administrative data records may comprise: verifying the pointers of the respective administrative data record; verifying a balance of the data volume of the respective administrative data record and a total data volume of the administrative data records referenced by the pointers of the respective administrative data record; and verifying the signatures of the respective administrative data record.

A “balance” as used herein may refer to a zero/nil balance of a subtraction of data volumes.

According to a third aspect, a sharing function of a network domain is provided. The sharing function comprises a processor, being configured for: receiving a first administrative data record of a first set of administrative data records from a user plane function of the network domain; sending the first administrative data record; receiving a second administrative data record of a second set of administrative data records; verifying the first and/or second administrative data records; selecting a leader among the sharing functions of the network domains; and committing a third administrative data record of the first and second sets of administrative data records to a local copy of a distributed ledger of the network domains.

The technical effects and advantages described above in relation with the method of the first aspect equally apply to the sharing function of the third aspect having corresponding technical features.

According to a fourth aspect, a sharing function of a network domain is provided. The sharing function comprises a processor, being configured for: receiving a first administrative data record of a first set of administrative data records from a user plane function of the network domain; verifying the first administrative data record; committing the first administrative data record to a local copy of a distributed ledger of the network domains; receiving a second ledger data block by the sharing function of the network domain, the second ledger data block comprising a second administrative data record of a second set of administrative data records and a reference to a second preceding administrative data record of the local copy of the distributed ledger; verifying the second administrative data record; and committing the second administrative data record to the local copy of the distributed ledger of the network domains.

The technical effects and advantages described above in relation with the method of the first aspect equally apply to the sharing function of the fourth aspect having special technical features.

According to a fifth aspect, a computer program is provided comprising executable instructions which, when executed by a processor, cause the processor to perform the method of the first aspect or the method of the second aspect, or any of their implementations.

### BRIEF DESCRIPTION OF DRAWINGS

The above-described aspects and implementations will now be explained with reference to the accompanying drawings, in which the same or similar reference numerals designate the same or similar elements.

The drawings are to be regarded as being schematic representations, and elements illustrated in the drawings are not necessarily shown to scale. Rather, the various elements are represented such that their function and general purpose become apparent to those skilled in the art.

FIG. 1 illustrates an exemplary cross-domain scenario in accordance with the present disclosure;

FIG. 2 illustrates a flow chart of a most generic implementation of the method of the first aspect in accordance with the present disclosure;

FIG. 3 illustrates an interaction of more detailed role-specific flow charts of the method of the first aspect in accordance with the present disclosure;

FIG. 4 illustrates a flow chart of a most generic implementation of the method of the second aspect in accordance with the present disclosure;

FIG. 5 illustrates an interaction of more detailed flow charts of the method of the first aspect in accordance with the present disclosure;

FIG. 6 illustrates an administrative data record in accordance with the present disclosure; and

FIGS. 7-8 illustrate various ledger data blocks in accordance with the present disclosure.

### DETAILED DESCRIPTIONS OF DRAWINGS

In the following description, reference is made to the accompanying drawings, which form part of the disclosure, and which show, by way of illustration, specific aspects of implementations of the present disclosure or specific aspects in which implementations of the present disclosure may be used. It is understood that implementations of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding apparatus or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary implementations and/or aspects described herein may be combined with each other, unless specifically noted otherwise.

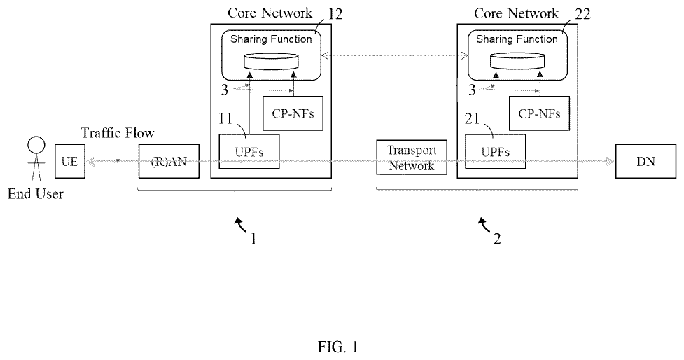

FIG. 1 illustrates an exemplary cross-domain scenario in accordance with the present disclosure.

A traffic flow session of a user equipment (UE) is transmitted through at least two exemplary network domains 1, 2 and an exemplary data network (DN), and DV and EC measurement data for this flow session need to be collected and shared among the two network domains directly without the participation of any third party.

More specifically, the exemplary traffic flow traverses a RAN and a core network of network domain 1, traverses a transport network and a core network of network domain 2 and then arrives at its uplink destination DN. For downlink destination, the flow session goes reversely the same way from the DN back to the UE. Within the respective core network, the exemplary traffic flow is subject to data plane processing by one or more UPFs 11, 21 respectively being configured for packet routing and data forwarding.

The present disclosure particularly deals with cross-domain sharing of administrative data, in particular measurement data relating to traffic flows, between the network domains 1, 2.

To this end, the one or more UPFs 11, 21 and/or some control plane network functions (CP-NFs) may be configured for measurement and reporting of such administrative data.

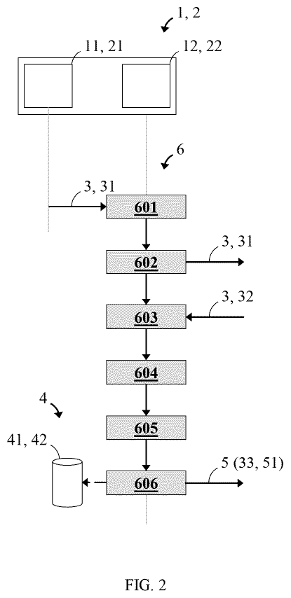

So within the respective network domain 1, 2, the UPFs 11, 21 and/or CP-NFs may collect the administrative data in the form of administrative data records 3 for sharing by means of sharing functions 12, 22. The purposes of sharing the administrative data among different domains can be various. For example, it can be for multi-domain auditing/billing purpose, end-to-end KPI monitoring purpose, end-to-end energy saving coordination planning purpose and so on. An operation of the sharing functions 12, 22 will be explained in more detail in connection with FIGS. 2-5 below.

FIG. 2 illustrates a flow chart of a most generic implementation of the method 6 of the first aspect in accordance with the present disclosure.

The method 6 may achieve a sharing of administrative data between network domains 1, 2 based on a “leader” role among the involved sharing functions 12, 22.

The flow chart is arranged below a schematic functional representation of a network domain 1, 2 comprising a UPF 11, 21 and a sharing function 12, 22.

The method 6 comprises a step of receiving 601 a first administrative data record 3, 31 of a first set of administrative data records 3 from the UPF 11, 21 of the respective network domain 1, 2. That is to say, the sharing function 12, 22 collects the first administrative data record 3, 31 (i.e., <DV:EC> Measurement Data).

Accordingly, the first administrative data record 3, 31 is representative of administrative data of the respective network domain 1, 2.

The method 6 further comprises a step of sending 602 the first administrative data record 3, 31 by the sharing function 12, 22 of the respective network domain 1, 2. The sharing function thus propagates the first administrative data record 3, 31 to peer sharing functions. This can use broadcast or anycast to peer sharing functions that join in the distributed ledger 4.

Note that each network domain 1, 2 collects and shares administrative data with its specific set of peer network domains.

The method 6 further comprises a step of receiving 603 a second administrative data record 3, 32 of a second set of administrative data records 3 by the sharing function 12, 22 of the respective network domain 1, 2.

Thus, the second administrative data record 3, 32 is representative of administrative data of a peer network domain.

Note that as each network domain 1, 2 shares administrative data with its specific set of peer network domains, it follows that the respective network domain 1, 2 may in turn receive different administrative data from its specific set of peer network domains.

The method 6 further comprises a step of verifying 604 the first and/or second administrative data records 3, 31, 32. More specifically, the sharing function 12, 22 meanwhile pre-verifies the received <DV:EC> Measurement Data, which may include the one collected by the sharing function 12, 22 itself. The verification criteria will be explained in more detail below.

The method 6 further comprises a step of selecting 605 a leader 12 among the sharing functions 12, 22 of the network domains 1, 2. Accordingly, the sharing function 12, 22 runs a distributed consensus protocol to select a leader in this round of ledger update, wherein the consensus protocol can utilize various existing protocols. For example, a consensus may be achieved interactively, wherein multiple rounds of signaling among the involved parties are required (e.g. PBFT, RAFT, PAXOS, Proof-of-Stake) or non-interactively (e.g., Proof-of-Work), see steps 6051 and 6052 below.

The method 6 further comprises a step of committing 606 a third administrative data record 3, 33 of the first and second sets of administrative data records 3 to a local copy 41, 42 of a distributed ledger 4 of the network domains 1, 2.

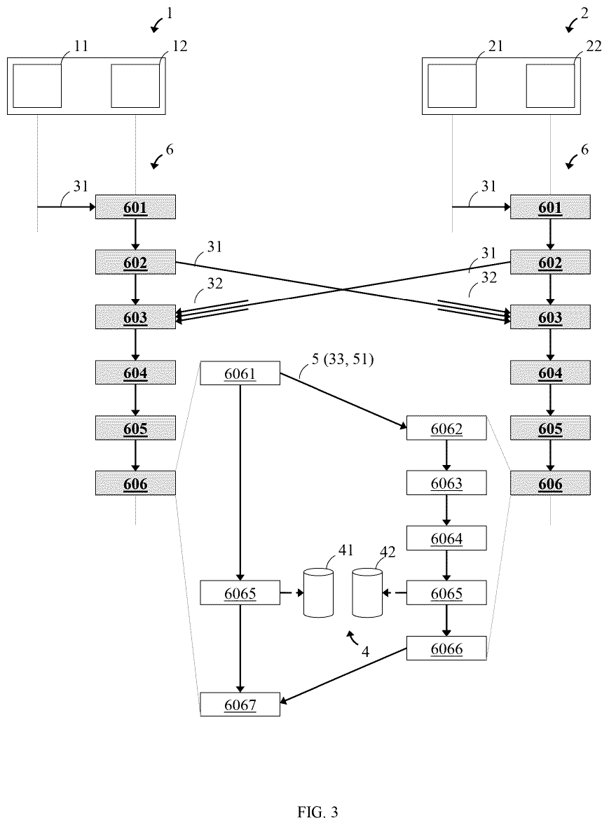

FIG. 3 illustrates an interaction of more detailed role-specific flow charts of the method 6 of the first aspect in accordance with the present disclosure.

The flow charts are arranged below schematic functional representations of respective network domains 1, 2 comprising respective UPFs 11, 21 and sharing functions 12, 22.

The selecting 605 step may comprise one step of
running 6051 an interactive consensus-building algorithm among the sharing functions 12, 22; and
running 6052 a non-interactive consensus-building algorithm by the respective sharing function 12, 22.

For the leader 12, the committing 606 step may comprise a step of

sending 6061 a ledger data block 5 and a token of the leader. The ledger data block 5 comprises the third administrative data record 3, 33 and a reference 51 to a preceding ledger data block 5 of the local copy 41 of the distributed ledger 4.

For any non-leader 22, the committing 606 step may comprise a step of

receiving 6062 the ledger data block 5 and the token of the leader.

The selected leader 12 that is one of the sharing functions 12, 22 may thus publish a prepared ledger update including a leader verification information (i.e., token) by broadcasting to peer sharing functions who were not elected as a leader.

For any non-leader 22, the committing 606 step may further comprise steps of
verifying 6063 the third administrative data record 3, 33, and
verifying 6064 the token of the leader.

Hence every non-leader sharing function 22 may post-verify a broadcasted ledger update by verifying the leader's token information and the verification criteria (see below). If this step passes, the sharing function 22 commits the broadcast ledger update and confirms the selected leader of this round.

For the leader 12 and any non-leader 22, the committing 606 step may thus comprise a step of

appending 6065 the ledger data block 5 to the preceding ledger data block 5.

For any non-leader 22, the committing 606 step may comprise a step of

sending 6066 a confirmation to the leader 12.

For the leader 12, the committing 606 step may further comprise a step of:

receiving 6067 the confirmation.

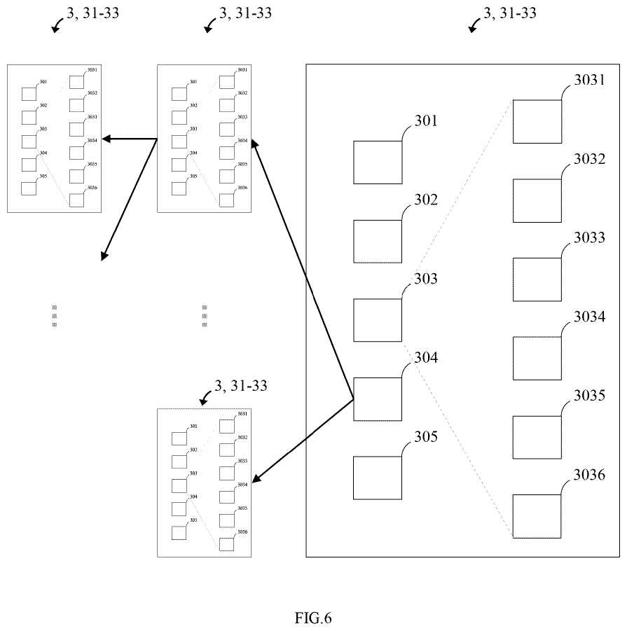

With reference to FIG. 6, the respective administrative data record 3, 31-33 may comprise, inter alia, an identifier 301, NE_ID of a user plane function 11, 21 of a network domain 1, 2 and measurement data 302, EC_MD, 303, DV_MD of the traffic flow, the measurement data 302, EC_MD, 303, DV_MD may in turn comprise energy consumption measurement data 302, EC_MD of the traffic flow and data volume measurement data 303, DV_MD of the traffic flow, and the data volume measurement data 303, DV_MD of the traffic flow may in turn comprise, inter alia, a data volume 3035, Egress_Bytes of the traffic flow during a time period 3034, TIME_SPOT, TIME_DURATION. The traffic flow extends between a source network entity 3032, SRC_ID and a destination network entity 3033, DST_ID. The administrative data record 3, 31-33 may further comprise one or more pointers 304, POINTER_LIST to administrative data records 3 for the traffic flow at ingress network entities.

Note that the data volume 3035, Egress_Bytes of the respective administrative data record 3, 31-33 should correspond to a total of the data volumes 3035, Egress_Bytes of the administrative data records 3 referenced by the pointers 304, POINTER_LIST of the respective administrative data record 3, 31-33.

Therefore, the verifying 604, 6063 steps may respectively comprise steps of
verifying the pointers 304, POINTER_LIST of the respective administrative data record 31, 32 themselves;
verifying a (zero) balance of the data volume 3035, Egress_Bytes of the respective administrative data record 31, 32 and a total data volume 3035, Egress_Bytes of the administrative data records 3 referenced by the pointers 304, POINTER_LIST of the respective administrative data record 31, 32; and
verifying the signatures 3036, V/P_NF_SIGNATURE, 305, SHARE_NF_SIGNATURE of the respective administrative data record 31, 32.

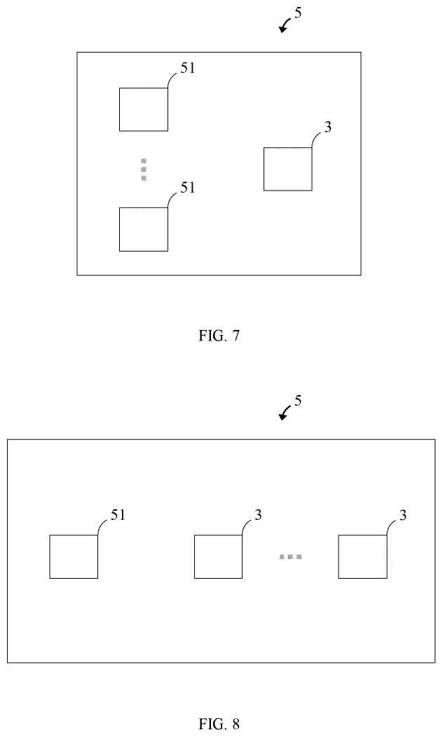

With reference to FIGS. 7-8, the ledger data block 5 may comprise: one or more administrative data records 3, and one or more references 51 to the preceding ledger data blocks 5 or to the preceding administrative data records 3.

Accordingly, the appending 6065 step may comprise one of
appending the ledger data block 5 by referencing a last ledger data block 5 of the local copy 41, 42; and
appending the ledger data block 5 by referencing one or more last ledger data blocks 5 of the local copy 41, 42 being determined by weighted random walks of the same.

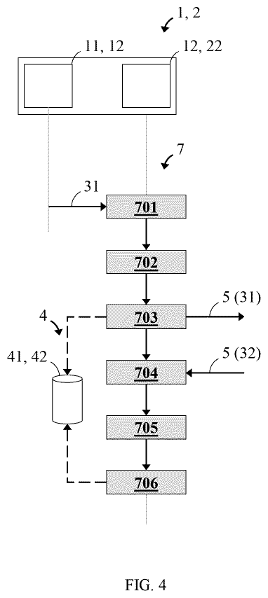

FIG. 4 illustrates a flow chart of a most generic implementation of the method 7 of the second aspect in accordance with the present disclosure.

The method 7 may achieve a sharing of administrative data between network domains 1, 2 based on equal roles of the involved sharing functions 12, 22.

The flow chart is arranged below a schematic functional representation of a network domain 1, 2 comprising a UPF 11, 21 and a sharing function 12, 22.

The method 7 comprises a step of receiving 701 a first administrative data record 3, 31 of a first set of administrative data records 3 from the UPF 11, 21 of the respective network domain 1, 2. That is to say, the sharing function 12, 22 collects the first administrative data record 3, 31 (i.e., <DV:EC> Measurement Data).

Accordingly, the first administrative data record 3, 31 is representative of administrative data of the respective/local network domain 1, 2.

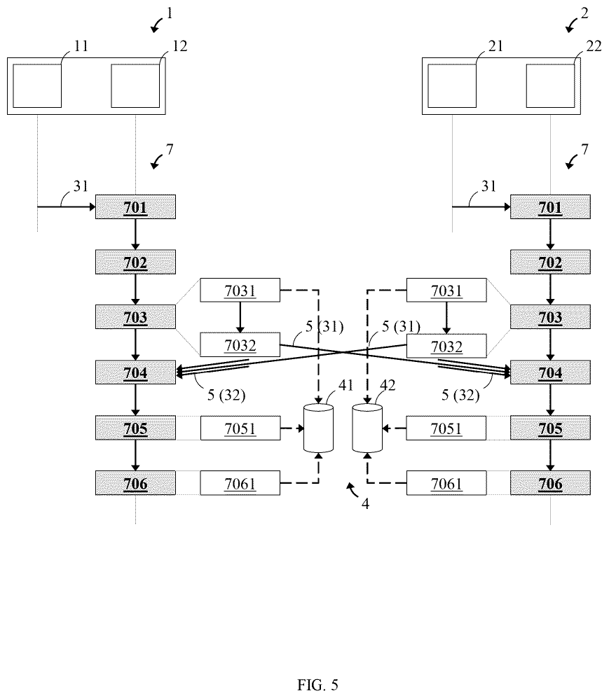

The method 7 further comprises a step of verifying 702 the first administrative data record 3, 31. More specifically, the sharing function 12, 22 meanwhile pre-verifies the <DV:EC> Measurement Data, which may include the one collected by the sharing function 12, 22 itself. The verification criteria will be explained in more detail in connection with FIG. 5 below.

The method 7 further comprises a step of committing 703 (and sharing) the first administrative data record 3, 31 to a local copy 41, 42 of a distributed ledger 4 of the network domains 1, 2.

Note that each network domain 1, 2 shares administrative data with its specific set of peer network domains.

The method 7 further comprises a step of receiving 704 a second ledger data block 5 by the sharing function 12, 22 of the respective network domain 1, 2.

The second ledger data block 5 comprises a second administrative data record 3, 32 of a second set of administrative data records 3 and a reference 51 to a second preceding administrative data record 3 of the local copy 41, 42 of the distributed ledger 4.

Thus, the second administrative data record 3, 32 is representative of administrative data of a peer network domain.

Note that as each network domain 1, 2 shares administrative data with its specific set of peer network domains, it follows that the respective network domain 1, 2 may in turn receive different administrative data from its specific set of peer network domains.

The method 7 further comprises a step of verifying 705 the second administrative data record 3, 32.

The method 7 further comprises a step of committing 706 the second administrative data record 3, 31 to the local copy 41, 42 of the distributed ledger 4 of the network domains 1, 2.

FIG. 5 illustrates an interaction of more detailed flow charts of the method 7 of the first aspect in accordance with the present disclosure.

The flow charts are arranged below schematic functional representations of respective network domains 1, 2 comprising respective UPFs 11, 21 and sharing functions 12, 22.

The committing 703 step may comprise a step of

appending 7031 a first ledger data block 5 to a first preceding ledger data block 5 of the local copy 41, 42 of the distributed ledger 4, the first ledger data block 5 comprising the first administrative data record 3, 31 and a reference 51 to the first preceding ledger data block 5.

In case of a chain of blocks ledger data structure, the new record block (i.e., first ledger data block 5) will be directly attached to the rear of the chain by referencing the hash value of the last record block (i.e., first preceding ledger data block 5) and including this information in the block header.

In case of a DAG ledger data structure, a weighted DAG random walk approach can be used to determine the attachment point (i.e., IOTA-like), wherein state transition weights can be generated with the policies defined as system configurations.

The committing 703 step may further comprise a step of

sending 7032 the first ledger data block 5 by a sharing function 12, 22 of the respective network domain 1, 2.

The sharing function 12, 22 may thus publish the record that has been attached into its local copy 41, 42 of the digital ledger 4 where the topological change information will be also included when publishing the record to peer sharing functions.

In addition, the sharing function 12, 22 will recursively request the publishing sharing functions 12, 22 for missing records of the ledger structure according to topological change information appended with the received record data.

The verifying 705 step may thus comprise a step of

recursively updating 7051 the local copy 41, 42 of the distributed ledger 4 in accordance with the reference 51 to the second preceding administrative data record 3 until the local copy 41, 42 comprises the second preceding administrative data record 3.

Until the missing records are completely appended, the sharing function 12, 22 may modify the local ledger structure with received records according to the topological change information appended with the record data.

The committing 706 step may comprise a step of

appending 7061 the second ledger data block 5 to the second preceding administrative data record 3.

With reference to FIG. 6, the respective administrative data record 3, 31-33 may comprise, inter alia, an identifier 301, NE_ID of a user plane function 11, 21 of a network domain 1, 2 and measurement data 302, EC_MD, 303, DV_MD of the traffic flow, the measurement data 302, EC_MD, 303, DV_MD may in turn comprise energy consumption measurement data 302, EC_MD of the traffic flow and data volume measurement data 303, DV_MD of the traffic flow, and the data volume measurement data 303, DV_MD of the traffic flow may in turn comprise, inter alia, a data volume 3035, Egress_Bytes of the traffic flow during a time period 3034, TIME_SPOT, TIME_DURATION. The traffic flow extends between a source network entity 3032, SRC_ID and a destination network entity 3033, DST_ID. The administrative data record 3, 31-33 may further comprise one or more pointers 304, POINTER_LIST to administrative data records 3 for the traffic flow at ingress network entities.

Note that the data volume 3035, Egress_Bytes of the respective administrative data record 3, 31-33 should correspond to a total of the data volumes 3035, Egress_Bytes of the administrative data records 3 referenced by the pointers 304, POINTER_LIST of the respective administrative data record 3, 31-33.

Hence, the verifying 702, 705 steps may respectively comprise steps of
verifying the pointers 304, POINTER_LIST of the respective administrative data record 31, 32;
verifying a balance of the data volume 3035, Egress_Bytes of the respective administrative data record 31, 32 and a total data volume 3035, Egress_Bytes of the administrative data records 3 referenced by the pointers 304, POINTER_LIST of the respective administrative data record 31, 32; and
verifying the signatures 3036, V/P_NF_SIGNATURE, 305, SHARE_NF_SIGNATURE of the respective administrative data record 31, 32.

With reference to FIGS. 7-8, the ledger data block 5 may comprise: one or more administrative data records 3, and one or more references 51 to the preceding ledger data blocks 5 or to the preceding administrative data records 3.

Thus, the appending 7031, 7061 steps may respectively comprise one of
appending the ledger data block 5 by referencing a last ledger data block 5 of the local copy 41, 42; and
appending the ledger data block 5 by referencing one or more last ledger data blocks 5 of the local copy 41, 42 being determined by weighted random walks of the same.

FIG. 6 illustrates an administrative data record 3 in accordance with the present disclosure.

The administrative data record 3, 31-33 may comprise an identifier 301, NE_ID of a user plane function 11, 21 of a network domain 1, 2 or an identity of the network entity that transports a traffic flow session in a public land mobile network (PLMN). It may further include a PLMN_ID of the serving network.

The administrative data record 3, 31-33 may further comprise measurement data 302, EC_MD, 303, DV_MD of the traffic flow.

The measurement data 302, EC_MD, 303, DV_MD may comprise energy consumption measurement data 302, EC_MD of the traffic flow and data volume measurement data 303, DV_MD of the traffic flow. That is to say, the DV and EC measurement data are combined into one data record, denoted as <DV:EC> Measurement Data.

A unit of the energy consumption measurement data 302, EC_MD of the monitored traffic flow session is kWh and the measurement data should be signed with a trusted authority, e.g., using a trusted execution environment (TEE) that is provided from an energy supply company. This measurement data can be obtained with existing method such as described in ETSI ES 202 336-12.

The data volume measurement data 303, DV_MD of the traffic flow may comprise an identity 3031, FS_ID of the traffic flow session transported by the serving NF (301, NE_ID); an identifier 3032, SRC_ID of a source network entity of the traffic flow; an identifier 3033, DST_ID of a destination network entity of the traffic flow (NULL if the traffic flow session terminates at the current serving NF); a time period 3034, TIME_SPOT, TIME_DURATION (wherein TIME_SPOT may indicate the time instant when the measurement data is collected, and TIME_DURATION may indicate the time period during which the measurement data is being collected); a data volume 3035, Egress_Bytes of the traffic flow during the time period; and a signature 3036, V/P_NF_SIGNATURE of the user plane function 11, 21 of the network domain 1, 2, which can be verified by other network entities.

The administrative data record 3, 31-33 may further comprise one or more pointers 304, POINTER_LIST to administrative data records 3 for the traffic flow at ingress network entities. The referenced administrative data records 3 relate to the upstream hop and to different time periods 3034, TIME_SPOT, TIME_DURATION. The destination of the traffic flow session of the referenced administrative data records 3 should be the same as NE_ID. The POINTER_LIST forms a semantic relationship between older and younger records by providing a trace information of intermediate the hops of the traffic flow session having traversed different network entities of different domains. The logical relationship will be explained in more detail in connection with FIG. 6 below.

Note that the data volume 3035, Egress_Bytes of the administrative data record 3, 31, 32 should correspond to a total of the data volumes 3035, Egress_Bytes of the administrative data records 3 referenced by the pointers 304, POINTER_LIST of the respective administrative data record 31, 32 (see verifying steps).

The administrative data record 3, 31-33 may further comprise a signature 305, SHARE_NF_SIGNATURE of the sharing function 12, 22 of the network domain 1, 2. This is the signature of the network function collecting the <DV:EC> Measurement Data, which can be verified by other network entities.

FIGS. 7 and 8 illustrate various ledger data blocks 5 in accordance with the present disclosure.

There are various options to organize the collected <DV:EC> Measurement Data in the local copies 41, 42 of the distributed ledger 4. The selection of a particular data structure depends on a collective decision of the participating sharing functions 12, 22.

Generally, the respective ledger data block 5 may comprise one or more administrative data records 3, and one or more references 51 to the preceding ledger data blocks 5 or to the preceding administrative data records 3.

As a first specific example (see FIG. 7), the ledger data block 5 may comprise a single administrative data record 3 and multiple references 51 to preceding ledger data blocks 5. In particular, the references 51 may comprise hash values of existing administrative data records 3. The respective ledger data blocks 5 may comprise meta information in the form of a block header. Based on this example, the distributed ledger may be organized in accordance with the DAG concept (i.e., as a DAG of individual transactions).

As a second specific example (see FIG. 8), the ledger data block 5 may comprise multiple administrative data records 3 and a single reference 51 to a preceding ledger data block 5. Based on this example, the distributed ledger may be organized in accordance with the block chain concept (i.e., as a linear chain of blocks of transactions).

In both specific examples, the meta information of either a record block or a record should provide topological information where the record (block/site) attaches to, such as the hash value(s) of one or multiple existing records in the local copy 41, 42 of the digital ledger 4, and verification information, which is a verifiable evidence to justify the modification with the included record(s). The specific form of the verification information differs with the ledger update procedure.

The present disclosure has been described in conjunction with various implementations as examples. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation. A computer program may be stored/distributed on a suitable medium, such as an optical storage medium or a solid-state medium supplied together with or as part of other hardware, but may also be distributed in other forms, such as via the Internet or other wired or wireless telecommunication systems.

1. A method (6) of sharing of administrative data between network domains (1, 2), the method (6) comprising
receiving (601) a first administrative data record (3, 31) of a first set of administrative data records (3) from a user plane function (11, 21) of the respective network domain (1, 2);
sending (602) the first administrative data record (3, 31) by a sharing function (12, 22) of the respective network domain (1, 2);
receiving (603) a second administrative data record (3, 32) of a second set of administrative data records (3) by the sharing function (12, 22) of the respective network domain (1, 2);
verifying (604) the first and/or second administrative data records (3, 31, 32);
selecting (605) a leader (21) among the sharing functions (12, 22) of the network domains (1, 2); and
committing (606) a third administrative data record (3, 33) of the first and second sets of administrative data records (3) to a local copy (41, 42) of a distributed ledger (4) of the network domains (1, 2).

2. The method (6) of claim 1,
wherein committing (606) the third administrative data record (3, 33) of the first and second sets of administrative data records (3) to the local copy (41, 42) of the distributed ledger (4) of the network domains (1, 2) comprises
sending (6061) a ledger data block (5) and a token of the leader by the leader (21), the ledger data block (5) comprising
the third administrative data record (3, 33), and
a reference (51) to a preceding ledger data block (5) of the local copy (41) of the distributed ledger (4);
appending (6065) the ledger data block (5) to the preceding ledger data block (5); and
receiving (6067) a confirmation by the leader (21).

3. The method (6) of claim 1,
wherein committing (606) the third administrative data record (3, 33) of the first and second sets of administrative data records (3) to the local copy (41, 42) of the distributed ledger (4) of the network domains (1, 2) comprises
receiving (6062) a ledger data block (5) and a token of the leader by a non-leader (22), the ledger data block (5) comprising
the third administrative data record (3, 33), and
the reference (51) to the preceding ledger data block (5) of the local copy (41, 42) of the distributed ledger (4);
verifying (6063) the third administrative data record (3, 33);
verifying (6064) the token of the leader;
appending (6065) the ledger data block (5) to the preceding ledger data block (5); and
sending (6066) a confirmation to the leader (21).

4. The method (6) of claim 2,
wherein selecting (605) the leader (21) among the sharing functions (12, 22) of the network domains (1, 2) comprises one of:
running (6051) an interactive consensus-building algorithm among the sharing functions (12, 22); and
running (6052) a non-interactive consensus-building algorithm by the respective sharing function (12, 22).

5. A method (7) of sharing of administrative data between network domains (1, 2), the method (7) comprising
receiving (701) a first administrative data record (3, 31) of a first set of administrative data records (3) from a user plane function (11, 21) of the respective network domain (1, 2);
verifying (702) the first administrative data record (3, 31);
committing (703) the first administrative data record (3, 31) to a local copy (41, 42) of a distributed ledger (4) of the network domains (1, 2);
receiving (704) a second ledger data block (5) by the sharing function (12, 22) of the respective network domain (1, 2), the second ledger data block (5) comprising
a second administrative data record (3, 32) of a second set of administrative data records (3), and
a reference (51) to a second preceding administrative data record (3) of the local copy (41, 42) of the distributed ledger (4);
verifying (705) the second administrative data record (3, 32); and
committing (706) the second administrative data record (3, 31) to the local copy (41, 42) of the distributed ledger (4) of the network domains (1, 2).

6. The method (7) of claim 5,
wherein verifying (705) the second administrative data record (3, 32) comprises
recursively updating (7051) the local copy (41, 42) of the distributed ledger (4) in accordance with the reference (51) to the second preceding administrative data record (3) until the local copy (41, 42) comprises the second preceding administrative data record (3).

7. The method (7) of claim 5,
wherein committing (703) the first administrative data record (3, 31) to the local copy (41, 42) of the distributed ledger (4) of the network domains (1, 2) comprises:
appending (7031) a first ledger data block (5) to a first preceding ledger data block (5) of the local copy (41, 42) of the distributed ledger (4), the first ledger data block (5) comprising
the first administrative data record (3, 31), and
a reference (51) to the first preceding ledger data block (5); and
sending (7032) the first ledger data block (5) by a sharing function (12, 22) of the respective network domain (1, 2).

8. The method (7) of claim 5,
wherein committing (706) the second administrative data record (3, 32) to the local copy (41, 42) of the distributed ledger (4) of the network domains (1, 2) comprises
appending (7061) the second ledger data block (5) to the second preceding administrative data record (3).

9. The method (7) of claim 7,
wherein appending (6065, 7031, 7061) the ledger data block (5) to the local copy (41, 42) of the distributed ledger (4) comprises one of:
appending the ledger data block (5) by referencing a last ledger data block (5) of the local copy (41, 42); and
appending the ledger data block (5) by referencing one or more last ledger data blocks (5) of the local copy (41, 42) being determined by weighted random walks of the same.

10. The method (7) of claim 5,
the respective administrative data record (3, 31, 32) comprising measurement data (302, EC_MD, 303, DV_MD) of a traffic flow.

11. The method (7) of claim 10,
the measurement data (302, EC_MD, 303, DV_MD) comprising:
energy consumption measurement data (302, EC_MD) of the traffic flow, and
data volume measurement data (303, DV_MD) of the traffic flow.

12. The method (7) of claim 11,
the data volume measurement data (303, DV_MD) of the traffic flow comprising:
an identifier (3031, FS_ID) of the traffic flow;
an identifier (3032, SRC_ID) of a source network entity of the traffic flow;
an identifier (3033, DST_ID) of a destination network entity of the traffic flow;
a time period (3034, TIME_SPOT, TIME_DURATION);
a data volume (3035, Egress_Bytes) of the traffic flow during the time period; and
a signature (3036, V/P_NF_SIGNATURE) of the user plane function (11, 21) of the respective network domain.

13. The method (7) of claim 12,
the respective administrative data record (3, 31, 32) comprising:
an identifier (301, NE_ID) of the user plane function (11, 21) of the network domain (1, 2);
the measurement data (302, EC_MD, 303, DV_MD) of the traffic flow;
one or more pointers (304, POINTER_LIST) to administrative data records (3) for the traffic flow at ingress network entities; and
a signature (305, SHARE_NF_SIGNATURE) of the sharing function (12, 22) of the network domain (1, 2).

14. The method (7) of claim 5.
the ledger data block (5) comprising:
one or more administrative data records (3), and
one or more references (51) to the preceding ledger data blocks (5) or to the preceding administrative data records (3).

15. The method (7) of claim 13,
wherein verifying (604, 6063, 702, 705) the first and/or the second administrative data records (3, 31, 32) comprises:
verifying the pointers (304, POINTER_LIST) of the respective administrative data record (31, 32);
verifying a balance of
the data volume (3035, Egress_Bytes) of the respective administrative data record (31, 32) and
a total data volume (3035, Egress_Bytes) of the administrative data records (3) referenced by the pointers (304, POINTER_LIST) of the respective administrative data record (31, 32); and
verifying the signatures (3036, V/P_NF_SIGNATURE, 305, SHARE_NF_SIGNATURE) of the respective administrative data record (31, 32).

16. A sharing function (12, 22) of a network domain (1, 2), the sharing function (12, 22) comprising a processor, being configured for:
receiving (601) a first administrative data record (3, 31) of a first set of administrative data records (3) from a user plane function (11, 21) of the network domain (1, 2);
sending (602) the first administrative data record (3, 31);
receiving (603) a second administrative data record (3, 32) of a second set of administrative data records (3);
verifying (604) the first and/or second administrative data records (3, 31, 32);
selecting (605) a leader (21) among the sharing functions (12, 22) of the network domains (1, 2); and
committing (606) a third administrative data record (3, 33) of the first and second sets of administrative data records (3) to a local copy (41, 42) of a distributed ledger (4) of the network domains (1, 2).
